(19) United States
(12) Patent Application Publication
(10) Pub. No.: US 2011/0083175 A1
(43) Pub. Date: Apr. 7, 2011

(54) Methods and Apparatuses for Policing and Prioritizing of Data Services

(75) Inventors: Shaun Jaikarran Bharrat, Manalapan, NJ (US); Justin Scott Hart, Swindon (GB); Jian Yang, Boxborough, MA (US)

(73) Assignee: Sonus Networks, Inc., Westford, MA (US)

(21) Appl. No.: 12/574,286

(22) Filed: Oct. 6, 2009

(51) Int. Cl. G06F 21/00; G06F 15/16

(52) U.S. Cl. 726/13; 709/224; 709/226

(57) ABSTRACT

Methods and apparatuses, including computer program products, are described for policing and prioritizing of data services. Each packet in a data stream is directed to a substream policer of a plurality of substream policers. Each packet is allowed through the substream policer based on rate parameters associated with the substream policer. The packets allowed by the substream policer are directed to an aggregate policer. Each packet allowed through the substream policer is allowed through the aggregate policer based on rate parameters associated with the aggregate policer. The substream policer and the aggregate policer are charged for each packet allowed by both the substream policer and the aggregate policer. The substream policer and the aggregate policer are not charged for each packet not allowed by either the substream policer or the aggregate policer.

### FIELD OF THE INVENTION

The subject matter of this application relates generally to methods and apparatuses, including computer program products, for policing and prioritizing of data services.

### BACKGROUND OF THE INVENTION

The fixed and limited resources associated with communications networks generally require a strategy for apportioning these resources among the many subscribers of the network. Enforcement of the apportionment strategy is an additional consideration to ensure that hyperactivity on the part of one or some subscribers does not affect the usability of the network for other subscribers. Typically, each subscriber is ascribed both an absolute limit on the number of resources allowed (e.g., number of calls and number of IM sessions) and also a limit on the rate of requests. The restrictions on absolute resource limits are usually implemented by some counting scheme, and the rate limits are enforced through some form of policing. Policing of network traffic commonly entails restricting the request rate from a particular entity to specified and desired parameters, where these parameters typically include both average request rates and burst sizes. The basic policing schemes all work well when all the requests from a subscriber are of the same class and characteristics.

However, many protocols allow the establishment of very disparate services on the same infrastructure. For example, the SIP protocol is particularly flexible and allows the establishment of, for example, telephony calls, instant messaging, presence watching, and conferencing. Often, the sessions are not considered equivalent in importance, cost, or a variety of other metrics. Hence, some session types require priority over other session types from that same customer.

A basic building block for implementing traffic policing is through use of a policer. A policer receives network traffic (e.g., in packet form) and determines whether to allow the traffic to progress further in the network. Typically, the policer makes this determination based on attributes of the traffic, as well as a cost associated with a level of work the policer must do to allow the traffic to progress further. As a result, the policer locally maintains a credit amount against which the cost of allowing a unit of data to progress can be charged. The policer replenishes its credit amount to ensure that sufficient credit is available for subsequent units of data to be allowed.

A common type of policer is a token bucket policer. The token bucket policer includes a bucket where the size of the bucket is the desired burst size (B_{c}). The bucket is filled with tokens at the desired policing rate (R_{c}). After a certain time interval (T_{c}), therefore, the bucket will have Tᵢ×R_{c} tokens. The number of tokens can never exceed B_{c} because once the token count reaches the bucket size, the excess tokens spill out and are lost. For example, using a token bucket policer, policing of a traffic stream may work as follows: when a packet is presented to the policer, the bucket is checked for tokens. If a token is present, then it is removed from the bucket and the packet passed. If the bucket is empty, then the packet is disallowed.

Generally, if the packet arrival rate Rₐ is exactly the policing rate R_{c}, then all packets will be allowed and the token level in the bucket will remain roughly constant. If the packet arrival rate Rₐ is less than the policing rate R_{c}, then the bucket will fill up to a maximum of B_{c}, and a burst of packets beyond the policing rate R_{c} will be allowed. Finally, if the packet arrival rate Rₐ is greater than the policing rate R_{c}, then the number of packets equal to the policing rate R_{c} will be allowed through and the bucket will be mostly empty. Consequently, the token bucket allows an average rate of R_{c} with a maximum burst of B_{c} as desired.

Unfortunately, conventional policers are inadequate for enforcing practical service level agreements (SLAs) involving disparate types of services.

A need therefore exists for improved methods and apparatuses for policing and prioritizing of data services.

### SUMMARY

In general overview, the techniques described herein are related to policing and prioritizing data traffic transmitted through a communications network, where the traffic can comprise substreams related to a number of disparate services. The techniques can provide a multi-stage policing approach. The techniques can allow for classifying, monitoring, and policing each of the substreams independently of any of the other substreams. Once the substreams have been policed, the techniques can prioritize and consolidate the substreams for policing at an aggregate level. If traffic is not allowed through the aggregate policing level due to rate or burst violations, the techniques advantageously can undo a previously-incurred charge associated with allowing the traffic at the substream level. Similarly, if traffic is allowed through the aggregate policing level, the techniques advantageously can apply a previously-deferred charge associated with allowing the traffic at the substream level. As a result, the techniques can ensure that subsequent substream traffic is not affected by a decision to allow or deny the traffic through the aggregate level.

The invention, in one aspect, features a computerized method for policing and prioritizing of data services. The method includes directing each packet in a data stream to a substream policer of a plurality of substream policers. The method also includes determining whether to allow each packet through the substream policer based on rate parameters associated with the substream policer. The method also includes directing the packets allowed by the substream policer to an aggregate policer. The method also includes determining whether to allow each packet allowed by the substream policer through the aggregate policer based on rate parameters associated with the aggregate policer. The method also includes charging the substream policer and the aggregate policer for each packet allowed by both the substream policer and the aggregate policer. The method also includes not charging the substream policer and the aggregate policer for each packet not allowed by either the substream policer or the aggregate policer.

The invention, in another aspect, features a computerized method for policing and prioritizing of data services with N policing stages, wherein N is greater than 2. The method includes directing a packet in a data stream to a policer in a policing stage K, wherein the policing stage K includes a plurality of policers. The method also includes determining whether to allow the packet through the policer in the policing stage K based on rate parameters associated with the policer in the policing stage K. The method also includes directing the packet allowed by the policer in the policing stage K to a policer in a subsequent policing stage K+1, wherein the policing stage K+1 includes fewer policers than the policing stage K. The method also includes determining whether to allow the packet allowed by the policer in the policing stage K through the policing stage K+1 based on rate parameters associated with the policer in the policing stage K+1. The method also includes charging a policer for the packet if the packet has been allowed by a policer in each of the N policing stages. The method also includes not charging a policer for the packet if the packet has not been allowed by a policer in any one of the N policing stages.

The invention, in another aspect, features a system for policing and prioritizing of data services. The system includes a substream classification module configured to direct each packet in a data stream to a substream policer of a plurality of substream policers based on one or more attributes of the packet, wherein the substream policer is configured to determine whether to allow each packet through the substream policer based on rate parameters associated with the substream policer. The system also includes an aggregate policer configured to receive the packet allowed by the substream policer and determine whether to allow it through the aggregate policer based on rate parameters associated with the aggregate policer. The system also includes a logical gate configured to send a command to the substream policer to either (i) charge the substream policer if the packet has been allowed by the aggregate policer or (ii) undo a charge of the substream policer if the packet has not been allowed by the aggregate policer.

The invention, in another aspect, features a system for policing and prioritizing of data services. The system includes means for directing each packet in a data stream to a substream policer of a plurality of substream policers. The system also includes means for determining whether to allow each packet through the substream policer based on rate parameters associated with the substream policer. The system also includes means for directing the packets allowed by the substream policer to an aggregate policer. The system also includes means for determining whether to allow each packet allowed by the substream policer through the aggregate policer based on rate parameters associated with the aggregate policer. The system also includes means for charging the substream policer and the aggregate policer for each packet allowed by both the substream policer and the aggregate policer. The system also includes means for not charging the substream policer and the aggregate policer for each packet not allowed by either the substream policer or the aggregate policer.

The invention, in another aspect, features a computer program product, tangibly embodied in a computer readable storage medium, for policing and prioritizing of data services. The computer program product includes instructions operable to cause a data processing apparatus to direct each packet in a data stream to a substream policer of a plurality of substream policers. The computer program product also includes instructions operable to cause a data processing apparatus to determine whether to allow each packet through the substream policer based on rate parameters associated with the substream policer. The computer program product also includes instructions operable to cause a data processing apparatus to direct the packets allowed by the substream policer to an aggregate policer. The computer program product also includes instructions operable to cause a data processing apparatus to determine whether to allow each packet allowed by the substream policer through the aggregate policer based on rate parameters associated with the aggregate policer. The computer program product also includes instructions operable to cause a data processing apparatus to charge the substream policer and the aggregate policer for each packet allowed by both the substream policer and the aggregate policer. The computer program product also includes instructions operable to cause a data processing apparatus to not charge the substream policer and the aggregate policer for each packet not allowed by either the substream policer or the aggregate policer.

In some examples, any of the above aspects can include one or more of the following features. Directing each packet in a data stream to a substream policer of a plurality of substream policers can include selecting the substream policer based on one or more attributes of the packet. Selecting the substream policer based on one or more attributes of the packet can include assigning a substream identifier to the packet based on the selected substream policer. Not charging the substream policer and the aggregate policer for each packet not allowed by either the substream policer or the aggregate policer can include undoing a charge in the substream policer for each packet not allowed by the aggregate policer. Charging the substream policer and the aggregate policer for each packet allowed by both the substream policer and the aggregate policer can include deferring a charge in the substream policer until the packet is allowed by the aggregate policer.

In one embodiment, determining whether to allow each packet, allowed by the substream policer, through the aggregate policer can include not allowing a packet, dropping the packet, and directing a drop indicator to a logical gate. The logical gate can direct a command to the substream policer to update a state associated with the substream policer based on the drop indicator. The substream policer can be identified based on a substream identifier assigned to the dropped packet. The substream policer can be identified based on a substream identifier assigned to the drop indicator.

In some examples, the aggregate policer is a priority policer and the packets are prioritized by the priority policer after being allowed by the substream policer. Prioritizing the packets allowed by the substream policer can include classifying each of the allowed packets based on one or more attributes of the allowed packet, and assigning a priority to the allowed packet based on the classification. In some embodiments, classifying each of the allowed packets is not based on the determination by the substream policer to allow the packet.

In some examples, the one or more attributes of the packet used to select the substream policer can include at least one of content data associated with the packet or metadata associated with the packet. The content data associated with the packet can include at least one of data associated with one or more network protocol headers of the packet, data associated with one or more application headers of the packet, or data associated with the packet payload. The metadata associated with the packet can include at least one of a packet arrival interface, upstream router identification, VLAN identification, or access medium identification. The one or more attributes of the packet used to classify each of the allowed packets can include at least one of content data associated with the packet or metadata associated with the packet. The content data associated with the packet can include at least one of data associated with one or more network protocol headers of the packet, data associated with one or more application headers of the packet, or data associated with the packet payload. The metadata associated with the packet can include at least one of a packet arrival interface, upstream router identification, VLAN identification, or access medium identification. The one or more attributes of the packet used to select the substream policer can be different than the one or more attributes of the packet used to classify each of the allowed packets.

In other examples, each substream policer operates independently of any other substream policers. The determination made by a substream policer of whether to allow a packet does not affect the determination made by any other substream policers of whether to allow any other packets. The plurality of substream policers can include token bucket policers, leaky bucket policers, or any combination thereof. The rate parameters associated with the substream policer can include at least one of the traffic rate or the burst size. The aggregate policer can include a token bucket policer or a leaky bucket policer. The rate parameters associated with the aggregate policer can include at least one of the traffic rate or the burst size.

Any of the examples described herein can contain one or more of the following advantages. In some embodiments, the data stream is first separated into substreams for policing, and unallowed packets on any of the substreams do not affect allowed packets on any other substream, regardless of whether the substream containing the unallowed packet is at a lower, equal, or higher precedence than another substream containing the allowed packet. In some embodiments, the aggregate policer ensures that priority of allowed packets from the substreams is maintained by dropping packets from the lower priority substreams first when the sum of the allowed packets exceeds the allowable rate of the aggregate policer. In some embodiments, not charging the substream policer and the aggregate policer when a packet allowed by the substream policer is dropped by the aggregate policer ensures that future packets conforming to both the substream and aggregate policer rate parameters will not be erroneously affected by current packets that are allowed by the substream policer but dropped by the aggregate policer.

### DESCRIPTION OF FIGURES

FIG. 1 is a block diagram of an exemplary system for policing and prioritizing data services.

FIG. 2 is a flow diagram of an exemplary method for policing and prioritizing data services.

FIG. 3 is a block diagram of an exemplary substream classifier.

FIG. 4 is a block diagram of an exemplary substream policer.

FIG. 5 is a block diagram of an exemplary priority classifier.

FIG. 6 is a block diagram of an exemplary aggregate policer.

FIG. 7 is a block diagram of an exemplary logical gate.

FIG. 8 is a flow diagram of an exemplary method for undoing a charge of substream policers for packets dropped by an aggregate policer.

FIG. 9 is a block diagram of an exemplary system for policing and prioritizing data services with N policing stages.

### DETAILED DESCRIPTION

In general overview, the techniques described below include methods and apparatuses for policing and prioritizing of data services. The techniques, including both methods and apparatuses, are related to policing of packet subflows within a traffic stream to desired parameters associated with the substream, and aggregating the packets allowed at the substream level for policing at an aggregate level. Some embodiments of the techniques are related to prioritizing packets allowed through the substream policers. Some embodiments of the techniques are related to not charging a substream policer for a packet if the packet is allowed at the substream level but is subsequently rejected at the aggregate level, such that future packets at the substream policer are not adversely impacted by packets dropped at the aggregate level.

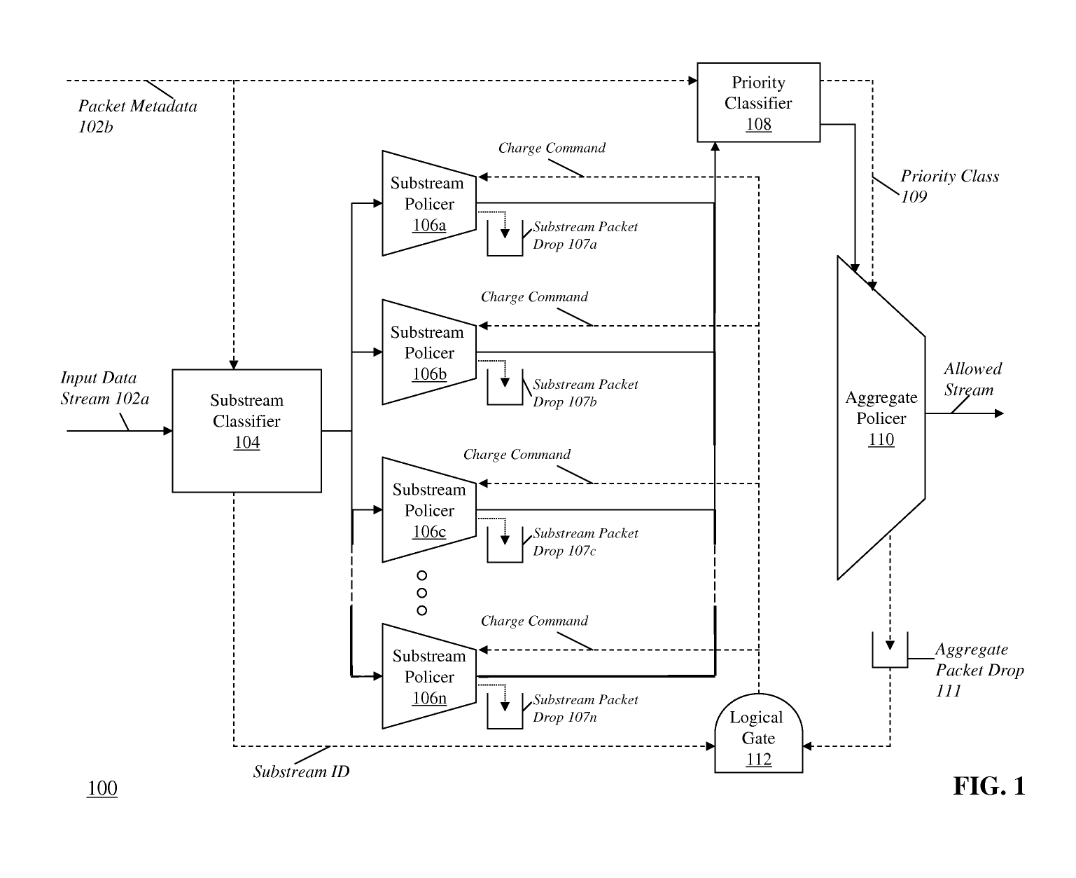

FIG. 1 is a block diagram of an exemplary system 100 for policing and prioritizing data services. The system 100 includes a substream classifier 104, one or more substream policers 106a-n (where ‘n’ denotes the number of substream policers), a substream packet drop 107a-n associated with each sub stream policer 106a-n, a priority classifier 108, an aggregate policer 110, an aggregate packet drop 111 associated with the aggregate policer 110, and a logical gate 112.

In some embodiments, the substream packet drop 107a-n can be a data link between the substream policer 106a-n and a device outside the system 100 over which the dropped packet is transmitted. In other embodiments, the substream packet drop 107a-n can be a physical memory location where dropped packets are stored for later processing. In still other embodiments, the substream packet drop 107a-n can be a device or module that destroys the dropped packets.

In some embodiments, the aggregate packet drop 111 can be a data link between the aggregate policer 110 and the logical gate 112 over which a drop indicator is transmitted. In other embodiments, the aggregate packet drop 111 can be a physical memory location where dropped packets are stored for later processing. In still other embodiments, the aggregate packet drop 111 can be a device or module that destroys the dropped packets.

The system 100 receives an input data stream 102a and packet metadata stream 102b. The input data stream 102a generally consists of a series of packets, which are units of data formatted for transmission over a communications network. A packet generally contains metadata (e.g., packet metadata stream 102b) and a payload. The packet metadata stream 102b comprises attributes related to the packet (e.g., arrival information, destination information, origin information, encoding protocols, or structure of information in the packet). The payload contains the user data to be transmitted.

While each of the components 104, 106a-n, 107a-n, 108, 110, 111, and 112 are represented in FIG. 1 as being contained within a single physical device, the components can alternatively reside in two or more different physical devices. The components and/or devices can communicate via a communications network (not shown), such as, for example, a local network (e.g., LAN) or a wide area network (e.g., Internet).

The substream classifier 104 receives an input data stream 102a and a packet metadata stream 102b associated with the input data stream 102a. The substream classifier 104 uses the contents of each packet in the input data stream 102a and/or packet metadata stream 102b associated with the packet to classify the packet into one of any number of predetermined classes. The contents of the packet can be data associated with any of the network protocol headers (e.g., Ethernet, IP, TCP/UDP/SCTP), any of the application headers (e.g., SIP, RTP, HTTP), or any of the data as originally placed into the packet or changed by an upstream node (e.g., DSCP value, discard-eligible (DE) bits). The packet metadata stream 102b can be any data associated with the context of the packet including data pertaining to transmission and/or arrival of the packet, such as the interface on which it arrived, the upstream router, the VLAN, the access medium (e.g., wired, wireless), or other similar attributes.

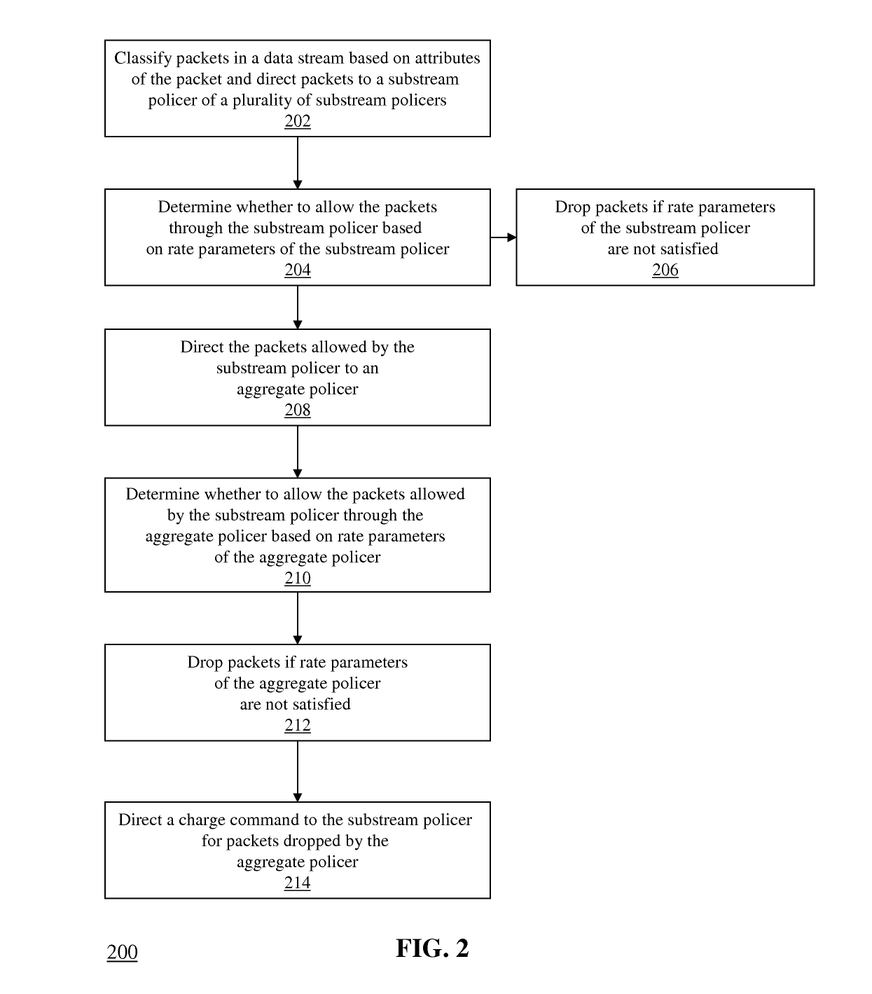

FIG. 2 is a flow diagram 200 of an exemplary method of policing and prioritizing data services using, for example, the system 100 of FIG. 1. The substream classifier 104 receives an input data stream 102a and a packet metadata stream 102b associated with the input data stream 102a, and classifies (202) each packet in the input data stream 102a based on one or more attributes of the packet. The substream classifier 104 directs each packet to one of the substream policers 106a-n according to the classification. The substream policer (e.g., substream policer 106a) determines (204) whether to allow the packet through the substream policer (e.g., substream policer 106a) based on rate parameters associated with the substream policer (e.g., substream policer 106a), such as a maximum rate and burst size for the specific substream. The substream policer (e.g., substream policer 106a) drops (206) unallowed packets. The substream policer (e.g., substream policer 106a) directs allowed packets to the priority classifier 108. The priority classifier 108 prioritizes each of the allowed packets based on one or more attributes of the allowed packet, and directs (208) the prioritized packets to the aggregate policer 110. The priority classifier 108 also directs a priority class 109 associated with the prioritized packets to the aggregate policer 110. The aggregate policer 110 determines (210) whether to allow the packets allowed by the substream policer through the aggregate policer 110 based on rate parameters associated with the aggregate policer 110 (e.g., a maximum rate and burst size for each priority value 109). The aggregate policer 110 directs allowed packets out of the system 100. The aggregate policer 110 drops (212) unallowed packets. The aggregate policer 110 transmits a drop indicator to a logical gate 112 if the aggregate policer 110 drops a packet. The logical gate 112 directs a charge command (214) to the substream policer (e.g., substream policer 106a). The substream policer (e.g., substream policer 106a) undoes a previously-applied charge based on the charge command received from the logical gate 112.

In another embodiment, the substream policer (e.g., substream policer 106a) defers a charge when it allows a packet. If the aggregate policer 110 also allows the packet, the aggregate policer 110 transmits an allow indicator to logical gate 112. The logical gate 112 directs a charge command (214) to the substream policer 106a. The substream policer 106a applies the previously-deferred charge based on receiving the charge command from the logical gate 112.

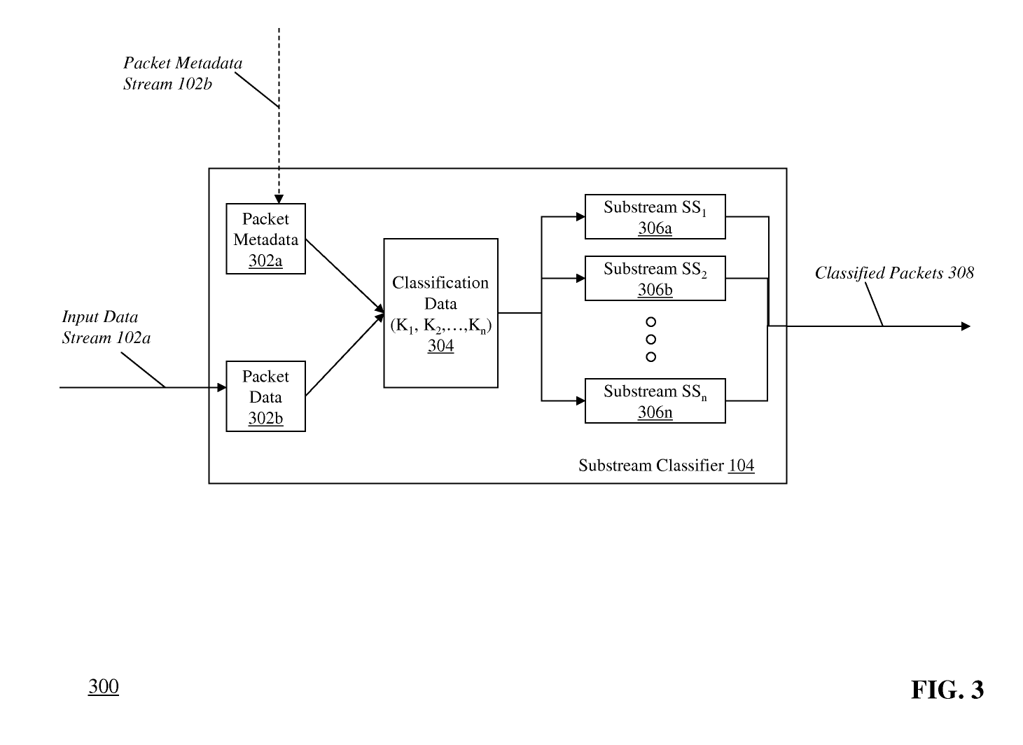

FIG. 3 is a block diagram 300 of an exemplary substream classifier (e.g., substream classifier 104). The packet data 302b from the input data stream 102a and the packet metadata 302a from the packet metadata stream 102b are received by the substream classifier 104. The substream classifier 104 extracts classification data 304 from the packet metadata 302a and/or from the packet data 302b. The classification data 304 can be, for example, the data content in the packet or metadata. For example, commonly used data include the request type (from the application data), the destination address (from the IP header), the source address (from the application data and/or the IP header), the receiving interface, and the media access type (wired versus wireless).

Each unique combination of values associated with the classification data 304 can be organized as a key for purposes of mapping the packet to a particular substream 306a-n. Each individual data field that comprises the classification data 304 is a component of the key (e.g., K₁, K₂, . . . , Kₙ). For example, if two packets contain identical values for each of the classification data fields, both packets would be associated with the same key and therefore be mapped to the same substream (e.g., substream 306a).

The substream classifier 104 maps the unique keys onto a set of substreams 306a-n (e.g., SS₁, SS₂, . . . , SSₙ). The substream classifier 104 can use a compression function to map the keys. For example, in one embodiment, the substream classifier 104 implements a function to map a larger domain of input values onto a smaller range of output values. In one example, a compression function involves hashing the key values to generate a substream index with a smaller range of values than the set of all possible combinations of key values. Hashing involves using an algorithm to convert a large, possibly variable-sized amount of data into a small datum, often a small integer that may serve as an index into an array. In another example, a compression function ignores as key values some of the extracted compression data 304 (e.g., based on requirements of the system 100). In some embodiments, the substream classifier 104 utilizes a one-to-one mapping function, where each unique key combination is mapped to a distinct substream (e.g., substream 306a). The one-to-one mapping function is desirable, for example, if a very limited set of input key values are used (e.g., the unique request types for a particular protocol). Any two packets with identical values for each of the key components (e.g., K₁, K₂, . . . , Kₙ) will be mapped to the same substream.

When the substream classifier 104 maps the packet to a substream, a substream identifier (e.g., SSₙ in 306n) is assigned to the packet and the substream identifier (e.g., SSₙ in 306n) determines which substream policer 106a-n is to be used. For example, if the substream identifier is SSₙ, then the packet belongs to substream SSₙ and the packet (e.g., classified packets 308) is directed to the substream policer for that substream. In some embodiments, the assignment of the substream identifier to a packet is implemented by modifying the packet to include the substream identifier within the packet. In some embodiments, the substream identifier can be transmitted separately to another component of the system 100. For example, the substream classifier 104 may output the substream identifier for a packet to the logical gate 112, as shown in FIG. 1. In another embodiment, the assignment of the substream identifier to a packet is implied by the system 100 since the identity of the substream policer (e.g., 306n) to which the packet is directed uniquely identifies the relevant substream (e.g., SSₙ) and does not, for example, require the substream identifier to be included in the packet.

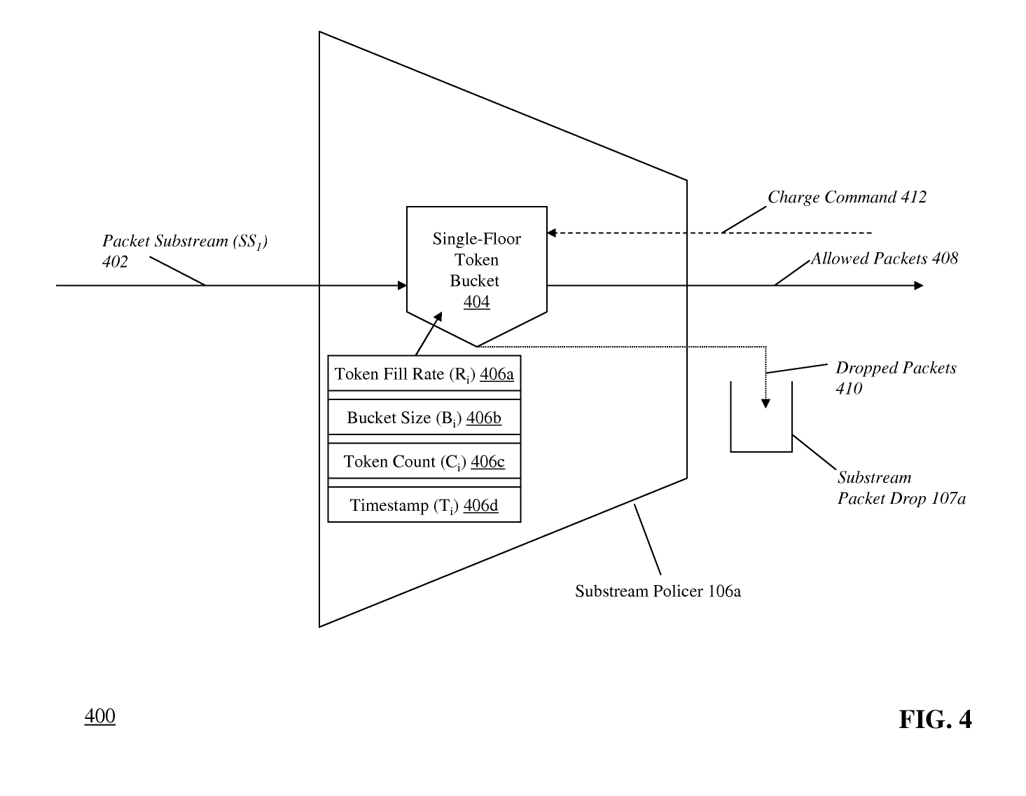

Once the packets have been classified and mapped to a particular substream by the substream classifier 104, the packets are directed to a substream policer (e.g., substream policers 106a-n). FIG. 4 is a block diagram 400 of an exemplary substream policer (e.g., substream policer 106a). The system 100 can include any number of substream policers (e.g., substream policers 106a-n). Each substream policer 106a-n is configured with a maximum rate and burst size for that specific substream.

Although the substream policer techniques of FIG. 4 described herein are directed to the use of a single-floor token bucket policer, the techniques are not limited to only this type of policer. Any policing mechanism can be used that can determine whether a particular unit of data at a particular time meets configurable constraints on rate parameters (e.g., the traffic rate or burst size), and allow the unit of data to progress further in the network based on that determination while incurring a cost for a level of work associated with allowing the unit of data. Accordingly, a suitable policing mechanism of the invention will maintain an amount of credit against which the cost of allowing a unit of data can be charged. The policing mechanism can replenish its credit amount to ensure that sufficient credit is available for subsequent units of data to be allowed.

However, in some embodiments, it is not desirable to charge a policing mechanism for a unit of data that the policing mechanism had previously allowed if the unit of data is not allowed by other policing mechanisms in the system. For example, if an initial policing mechanism allowed a packet, thereby incurring a charge for allowing the packet, and a subsequent policing mechanism in the system did not allow the same packet, it is desirable to undo the charge incurred by the initial policing mechanism because the system did not in fact complete the amount of work needed to allow the packet through the entire system. Undoing the charge thus ensures that later packets processed by the initial policing mechanism are not erroneously affected because the initial policing mechanism does not have sufficient credit to absorb the cost of allowing the later packets.

In other embodiments, it is desirable to charge a policing mechanism for a unit of data that the policing mechanism had previously allowed only after the unit of data is allowed by policing mechanisms in the entire system. For example, if an initial policing mechanism allowed a packet, it is desirable to defer the charge that would have been incurred by the initial policing mechanism until the system completes the amount of work needed to allow the packet through the entire system. Deferring the charge thus ensures that later packets processed by the initial policing mechanism are not erroneously affected if a subsequent policing mechanism does not allow the packet.

In one embodiment of the invention, the substream policer 106a can be implemented as a single-floor token bucket 404. A token bucket is a traffic policing mechanism that determines when packets can be transmitted based on the number of tokens in the bucket. Generally, a token represents the cost charged to the policer to allow a unit of data. In one example, a token is a unit of bytes or a single packet of predetermined size. In another example, a token is a level of work the token bucket must do in order to allow a unit of data. Tokens in the bucket are removed for the ability to send a packet. A token bucket has a maximum bucket size, and the bucket is filled with tokens at a predetermined policing rate. The number of tokens in the bucket cannot exceed the bucket size because once the token count reaches the bucket size, the excess tokens spill out and are lost.

A single-floor token bucket (e.g., single-floor token bucket 404) contains a single floor level, usually defined as zero tokens. The single-floor token bucket will allow a packet through if a sufficient number of tokens above the floor level are available in the bucket. The single-floor token bucket does not distinguish between different types or prioritization of packets that arrive. For example, if a single-floor token bucket contains one token and a packet arrives, the single-floor token bucket will allow the packet through and remove the token from the bucket. The next packet to arrive will not be allowed through because there are no tokens available in the single-floor token bucket (i.e., no tokens above the zero floor level).

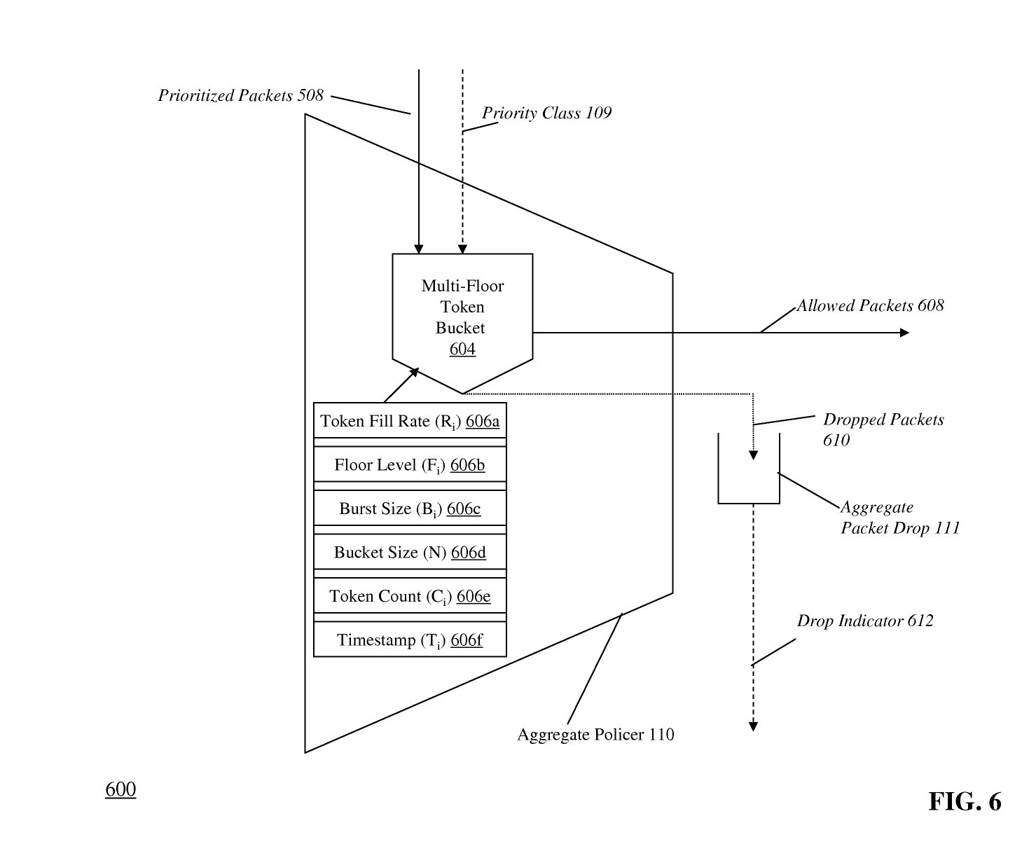

A multi-floor token bucket (e.g., multi-floor token bucket 604 in FIG. 6) contains more than one floor level, and the respective floor levels usually correspond to different prioritization of packets. The multi-floor token bucket will allow a packet through if a sufficient number of tokens above the floor level associated with the packet are available in the bucket. The floor level is higher for lower priority packets than for higher priority packets. In one example, a multi-floor token bucket is configured with four floor levels in ten-token increments (e.g., 1-10, 11-20, 21-30, 31-40). The multi-floor token bucket contains ten tokens and a packet arrives with a priority rate corresponding to the third floor level (i.e., 21-30). Since there are not at least twenty-one tokens in the multi-floor token bucket, the packet will not be allowed. If another packet arrives with a higher priority rate (e.g., 1-10), the packet will be allowed because the multi-floor token bucket contains more than one token.

The substream policer 106a determines whether the packet meets the desired policing rate for the substream (e.g., substream SS₁ 402). The token fill rate Rᵢ 406a of the single-floor token bucket (e.g., single-floor token bucket 404) is the steady-state committed rate for traffic of the substream 402. The bucket size Bᵢ 406b of the single-floor token bucket (e.g., single-floor token bucket 404) is the burst size for traffic of the substream 402. Each single-floor token bucket (e.g., single-floor token bucket 404) maintains a current token count Cᵢ 406c and also a time value Tᵢ 406d which denotes the time at which the single-floor token bucket (e.g., single-floor token bucket 404) was last filled with tokens. In some embodiments, the time value Tᵢ 406d is retrieved from a clock associated with the system 100.

When the substream policer 106a receives a packet from the substream classifier 104, the single-floor token bucket 404 checks the count of tokens in the single-floor token bucket 404. If a token is available, the token is removed and the token count 406c is reduced by one. The substream policer 106a then allows the packet (e.g., allowed packets 408) to pass through the substream policer 106a.

If a token is not available, then the single-floor token bucket 404 performs a token count update. As part of the update, the single-floor token bucket 404 computes a delta token count (ΔC) by determining the amount of time elapsed since the single-floor token bucket 404 was last filled (T_{now}−Tᵢ) and multiplying it by the fill rate Rᵢ to calculate the number of tokens to add to the single-floor token bucket 404. For example, if ΔC>=1, then the token count Cᵢ 406c is updated to min{(Cᵢ+ΔC−1), (Bᵢ−1)}, the time value Tᵢ 406d is updated to T_{now}, and the packet is allowed.

If there are insufficient tokens in the single-floor token bucket 404 after the update occurs, the packet is dropped (e.g., dropped packets 410) by the substream policer 106a. Dropping of the packet by the substream policer 106a can be considered as a logical drop, as a dropped packet may not necessarily be terminated by the system 100 but routed outside of the system 100. In some examples, the dropped packets 410 are marked and subsequently directed to a destination outside the system 100 (e.g., to another system or device for processing the dropped packets 410). In other examples, the dropped packets 410 are rejected altogether. In either example, packets dropped by the substream policer 106a are not processed by or directed to any other components of the system 100.

The substream policers 106a-n receive and police packets independently of each other. For example, each substream policer 106a-n can contain different rate parameters (e.g., the fill rate 406a and bucket size 406b for substream policer 106a may be different than the fill rate and bucket size for substream policer 106b). Furthermore, the activity of any one substream policer (e.g., substream policer 106a) does not affect the behavior or operation of any other substream policer (e.g., substream policer 106b). In particular, each substream policer 106a-n makes its policing decision independent of whatever packet traffic is flowing, or has previously flowed, through any of the other substream policers 106a-n, and independent of the policing decisions made by any of the other substream policers 106a-n.

In some embodiments, the substream policer 106a is not limited to removing a single token for each packet. The single-floor token bucket 404 in each substream policer (e.g., substream policer 106a) may have a distinct debit (Dᵢ), in which at least Dᵢ tokens must be available for the packet to be passed, and, if passed, Dᵢ tokens are removed from the single-floor token bucket 404. In addition, in some embodiments, the token count update technique is modified so that the single-floor token bucket 404 is periodically refilled according to the fill rate Rᵢ with any level of time granularity. For example, in some embodiments, the single-floor token bucket 404 can be refilled every second. In other embodiments, the single-floor token bucket 404 can be refilled every millisecond.

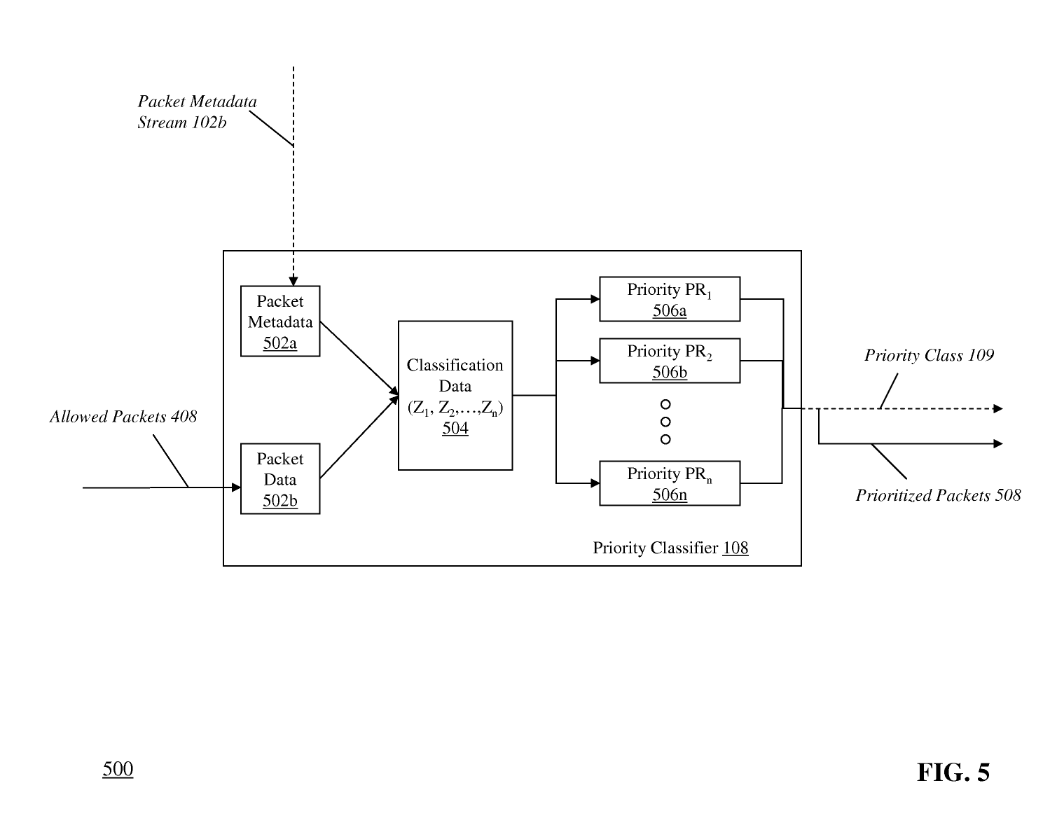

In some embodiments, after packets are allowed (e.g., allowed packets 408) through the substream policers 106a-n, the packets 408 are directed to a priority classifier. FIG. 5 is a block diagram 500 of an exemplary priority classifier (e.g., priority classifier 108 of FIG. 1). The priority classifier 108 uses the packet data 502b of each allowed packet (e.g., allowed packets 408) received from the substream policers 106a-n and packet metadata 502a associated with each allowed packet to classify each allowed packet into one of any number of priority classes (e.g., priority classes 506a-n). The packet data 502b of the allowed packets 408 and the packet metadata 502a associated with the packets can be of the same type as used by the substream classifier 104. However, while the classification data 504 available to the priority classifier 108 is similar to the classification data (e.g., classification data 304 of FIG. 3) available to the substream classifier 104, the classification conducted by the priority classifier 108 need not utilize the same algorithm, packet metadata 502a, or packet data 502b as utilized by the substream classifier 104. The number of priority classes 506a-n may be larger, or smaller, than the number of substream classes (SSₙ).

In addition, the priority classifier 108 can organize each unique combination of values associated with the classification data 504 as a key for purposes of mapping the allowed packet (e.g., allowed packets 408) to a particular priority class 506a-n. Each key defined by the priority classifier 108 is independent of the keys defined by the substream classifier 104, if the same or similar classification data is used.

The priority classifier 108 maps the unique keys onto a set of priority classes 506a-n (e.g., PR₁, PR₂, . . . , PRₙ). This mapping may be one-to-one where each key maps to a unique and distinct priority, or the mapping function may map more than one key to the same priority. The mapping function can also be a hybrid, mapping some keys to distinct priorities and other keys to shared priorities. The priority classifier 108 can use a compression function to map the keys. For example, in one embodiment, the priority classifier 108 implements a function to map a larger domain of input values onto a smaller range of output values. In one example, a compression function involves hashing the key values to generate a priority index with a smaller range of values than the set of all possible combinations of key values. In another example, a compression method ignores as key values some of the extracted compression data 504 (e.g., based on requirements of the system 100). In some embodiments, the priority classifier 108 utilizes a one-to-one mapping function, where each unique key combination is mapped to a distinct priority class (e.g., priority class 506a). The one-to-one mapping function is desirable, for example, if a very limited set of input key values are used (for example, the unique request types for a particular protocol). Any two packets with identical values for each of the key components (e.g., Z₁, Z₂, . . . , Zₙ) will be mapped to the same priority class (e.g., priority class 506a).

When the priority classifier 108 maps the packet to a priority class 506a-n, the priority classifier 108 assigns a priority value 109 to the packet. The priority value 109 is associated with a priority class (e.g., priority class PR₁ 506a). The priority classifier 108 then directs the priority value 109 to an aggregate policer (e.g., aggregate policer 110 of FIG. 1) coincident with the associated packet (e.g., prioritized packets 508) allowed by the substream policer 106a. The format of the priority value 109 from the priority classifier 108 depends on the policing mechanism of the aggregate policer 110. For example, if the aggregate policer 110 includes a multi-floor token bucket (e.g., multi-floor token bucket 604 of FIG. 6), the priority class PR₁ 506a corresponds to a floor level (e.g., Fᵢ) in the multi-floor token bucket. In some examples, the priority classifier 108 uses the following constraints to map the allowed packet to a priority class: (a) F₁>=0 and F₁<the number of substreams; (b) if PR₁>PR₂, then F₁<F₂; (c) if PR₁=PR₂, then F₁=F₂.

As shown in FIG. 1, the priority value 109 assigned by the priority classifier 108 is logically distinct from the actual allowed packet (e.g., prioritized packets 508) being directed to the aggregate policer 110. This need not be a physical separation. In some embodiments, the allowed packet (e.g., allowed packets 408 of FIG. 5) can be marked with the priority value 109 and then fed into the aggregate policer 110. Also, in other embodiments, the priority classifier 108 and the aggregate policer 110 need not be separate entities.

After the packets have been prioritized, the prioritized packets 508 are directed to the aggregate policer 110. FIG. 6 is a block diagram 600 of an exemplary aggregate policer (e.g., aggregate policer 110). Although the aggregate techniques of FIG. 6 described herein are directed to the use of a multi-floor token bucket policer, the techniques are not limited to only this type of policer. Any policing mechanism can be used that can determine whether a particular unit of data at a particular time meets configurable constraints on rate parameters (e.g., the traffic rate or burst size), and allow the unit of data to progress further in the network based on that determination while incurring a cost for a level of work associated with allowing the unit of data. Accordingly, a suitable policing mechanism of the invention will maintain an amount of credit against which the cost of allowing a unit of data can be charged. The policing mechanism can replenish its credit amount (e.g., number of tokens available) to ensure that sufficient credit is available for subsequent units of data to be allowed. The policing mechanism can also revert to a prior state, e.g., by replenishing credit associated with a cost it had previously incurred when it had allowed a unit of data. In this embodiment, the aggregate policer 110 is configured with a maximum rate (e.g., fill rate (Rᵢ) 606a), and a floor level (e.g., floor level (Fₜ) 606b) and burst size (e.g., burst size (Bᵢ) 606c) for each priority value 109, and is implemented as a multi-floor token bucket 604.

The aggregate policer 110 determines whether the prioritized packet meets the desired rate for the traffic flow. The fill rate Rᵢ 606a will be the maximum policing rate, and the floor Fᵢ 606b for each priority value 109 will be the overall bucket size N 606d reduced by the burst size Bᵢ 606c for that priority value 109. The multi-floor token bucket 604 maintains a current token count Cᵢ 606e and also a time value Tᵢ 606f which denotes the time at which the multi-floor token bucket 604 was last filled with tokens.

When the aggregate policer 110 receives a prioritized packet 508 and an assigned priority value 109 for the packet, the aggregate policer 110 checks the count of tokens in the multi-floor token bucket 604. If a token above the respective floor level Fᵢ 606b for the priority value 109 is available, i.e., Cᵢ>Fᵢ, then the aggregate policer 110 removes a token from the multi-floor token bucket 604, and allows the packet (e.g., allowed packets 608) to pass through. If a token is not available above the respective floor level Fᵢ 606b for the priority value 109, then a token count update is performed. This update computes a delta token count (ΔC) by determining the amount of time elapsed since the multi-floor token bucket 604 was last filled (T_{now}−Tᵢ) and multiplying it by the token fill rate Rᵢ 606a to calculate the number of tokens to add to the multi-floor token bucket 604. For example, if ΔC>=Fᵢ+1, then the token count 606e is updated to min {(Cᵢ+ΔC−1), (N−1)}, the time value Tᵢ 606f is updated to T_{now}, and the packet is allowed. In addition to allowing the packet through the aggregate policer 110, the aggregate policer 110 can direct a ‘negative’ drop indicator 612 to the logical gate 112.

If there are insufficient tokens above the respective floor level 606b for the priority value 109 in the multi-floor token bucket 604 after the update occurs, the packet is dropped (e.g., dropped packets 610) by the aggregate policer 110. In addition to dropping the packet, the aggregate policer 110 directs a ‘positive’ drop indicator 612 into the logical gate 112.

The aggregate policer 110 is not limited to removing a single token for each packet. The multi-floor token bucket 604 in the aggregate policer 110 may have a distinct debit (Dᵢ), in which at least Dᵢ tokens must be available for the packet to be allowed, and, if allowed, Dᵢ tokens are removed from the multi-floor token bucket 604. Also, the token count update technique can be modified so that the multi-floor token bucket 604 is periodically refilled according to the token fill rate Rᵢ 606a with any level of time granularity. For example, in some embodiments, the multi-floor token bucket 604 can be refilled every second. In other embodiments, the multi-floor token bucket 604 can be refilled every millisecond.

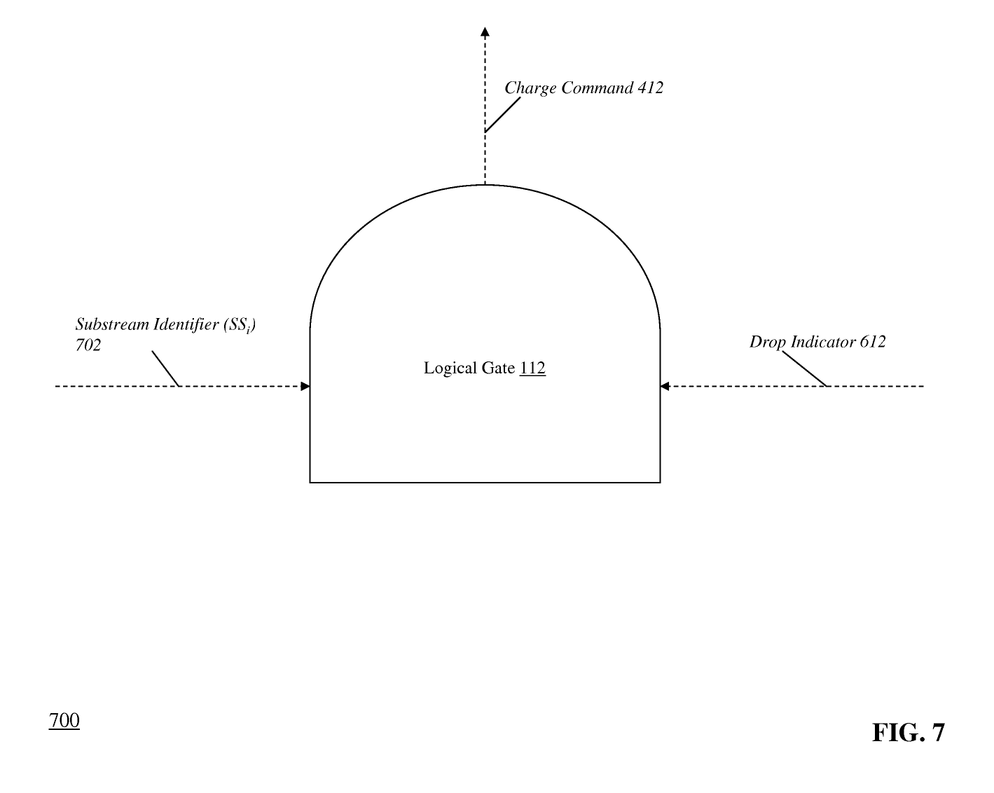

FIG. 7 is a block diagram 700 of an exemplary logical gate (e.g., logical gate 112). The drop indicator 612 from the aggregate policer 110 and the substream identifier 702 (e.g., SS₁) that was assigned to the packet by the substream classifier 104 are received by the logical gate 112. In some examples, the substream identifier 702 is received from the substream classifier 104. In other examples, the substream identifier 702 may be inserted into the packet and then extracted by the logical gate 112 or the substream identifier 702 may be inferred based on the identity of the substream policer 106a through which the packet had previously passed.

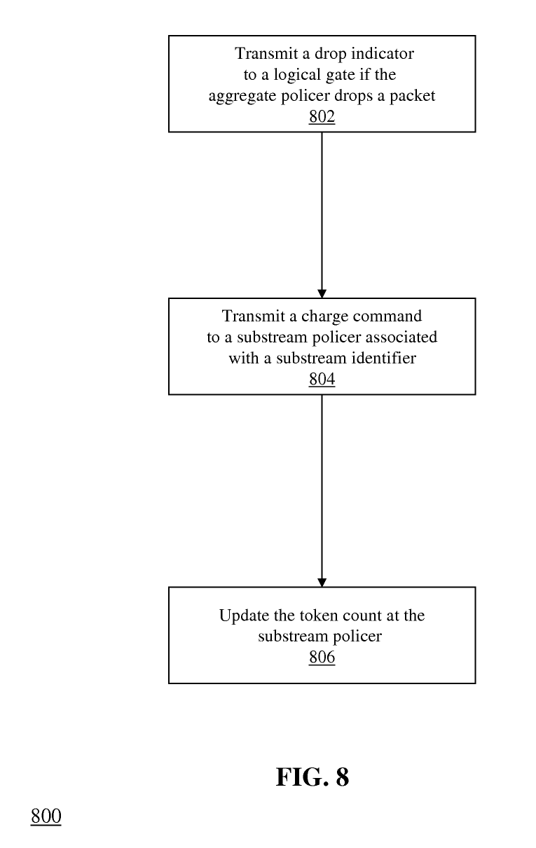

FIG. 8 is a flow diagram 800 of an exemplary method for undoing a charge of substream policers (e.g., substream policers 106a-n) for packets dropped (e.g., dropped packets 610) by an aggregate policer (e.g., aggregate policer 110). If the aggregate policer 110 transmits (802) a drop indicator 612 to the logical gate, then the logical gate 112 transmits (804) a charge command 412 back to the substream policer (e.g., substream policer 106a) associated with the respective substream identifier 702. Upon receiving the charge command 412, the substream policer 106a undoes a charge that it had previously applied by allowing the dropped packet, and the state of the substream policer 106a is updated to the equivalent of what it would have been had the dropped packet not passed through the sub stream policer 106a. In an alternative embodiment, the aggregate policer 110 transmits an allow indicator to the logical gate. The logical gate 112 transmits a charge command back to the substream policer (e.g., substream policer 106a) associated with the respective substream identifier 702. Upon receiving the charge command, the substream policer 106a applies a charge that it had previously deferred when it first allowed the packet allowed by the aggregate policer, and the state of the substream policer 106a is updated to the equivalent of what it should have been when the allowed packet first passed through the substream policer 106a.

For example, the substream policer 106a updates (806) its token count (e.g., token count 406c of FIG. 4) based on the charge command 412. As an illustration of this update, in one example, the substream policer 106a has a token count (e.g., token count (Cᵢ) 406c of FIG. 4) before a packet is allowed through the substream policer 106a The substream policer 106a allows the packet through and the token count 406c of the substream policer 106a is reduced to Cᵢ−Dᵢ, where Dᵢ is the distinct debit (e.g., the number of tokens to remove from the token count 406c), as the substream policer 106a directs the allowed packet to the priority classifier 108. However, in this example, the aggregate policer 110 drops the packet because, for example, there are not sufficient tokens in the multi-floor token bucket 604 at the respective floor level 606b for the priority value 109 assigned to the packet. The logical gate 112 combines the drop indicator 612 with the substream identifier 702 and directs a charge command 412 to the substream policer 106a. Accordingly, the substream policer 106a undoes a charge that it had previously applied when it allowed the packet by increasing the token count 406c of the single-floor token bucket 404 in the substream policer 106a by the distinct debit (Dᵢ), back to Cᵢ. The distinct debit (Dᵢ) is the number of tokens associated with the previously-applied charge. The distinct debit (Dᵢ) can be any number of tokens. In some embodiments, the distinct debit (Dᵢ) is one token.

The prior example is a simplified update. Generally, the state of the substream policer 106a after the charge command 412 is received and processed will not be exactly the same as if the packet had not been allowed by the substream policer 106a at all. For example, suppose at time T_{1now}, the packet was received by the substream policer 106a. Let Cᵢ₀ and Tᵢ₀ be the token count 406c and the time value 406d associated with the substream policer 106a at that point. Let Dᵢ be the distinct debit (e.g., the number of tokens associated with the charge incurred by the substream policer 106a for allowing the packet). If Cᵢ₀=0, then the token count Cᵢ₁ (e.g., token count 406c) of the substream policer 106a after the packet had been allowed would have been updated as

Cᵢ₁=Cᵢ₀+{(T_{1now}−Tᵢ₀)×Rᵢ−Dᵢ}; or

Cᵢ₁={(T_{1now}−Tᵢ₀)×Rᵢ−Dᵢ},

and the time value Tᵢ₁ of the substream policer 106a (e.g., time value 406d) would have been updated to:

Tᵢ₁=T_{1now}.

If the aggregate policer 110 eventually rejects the packet at time T₂, then the state of the substream policer 106a is updated in a manner similar to that described above. However, the update adds the distinct debit (Dᵢ) back resulting in a token count 406c of:

Cᵢ₂=Cᵢ₁+Dᵢ₀

Cᵢ₂={(T_{1now}=Tᵢ₀)×Rᵢ−Dᵢ+Dᵢ}

Cᵢ₂={(T_{1now}−Tᵢ₀)×Rᵢ}

with the time value 406d remaining at:

Tᵢ₂=Tᵢ₁=T_{1now}

Hence, the internal state of Pᵢ at Tᵢ₀ differs from the internal state at Tᵢ₂:

Cᵢ₀=0≠Cᵢ₂={T_{1now}−Tᵢ₀)×Rᵢ}

Tᵢ₀≠Tᵢ₂=T_{1now}

However, the two states are equivalent and would produce the same policing result for subsequent packets. In effect, the state at T₂ amounts to a preloading of earned tokens into the single-floor token bucket 404, but does not result in any extra policing tokens.

### Example Use Case

As one example, a service provider services a customer with a contracted rate. Further, the customer has both an overall rate allowance but also an individualized allowances for specific types of requests within that rate. For the individual requests, the requests can be allowed provided that the current overall rate limits aren't exceeded and that other requests types are being allowed their individualized rates.

This example can be an SIP service provider servicing a SIP customer. The SIP customer might be allowed to use SIP for making calls, for instant-messaging, and for presence monitoring of his or her friends. From the providers' perspective, the customer has an allowed overall rate. This overall rate must be enforced to ensure that over-usage by this customer doesn't affect another customer who is sharing the same underlying provider network. However, the customer, and sometimes the provider, might want to meter the different services that the customer is using. For example, the customer might want to ensure that instant-messaging (from his or her children) doesn't affect the ability to make telephone calls.

In this example, the provider allows the customer an aggregate request rate of 10 requests per second, of which a maximum of 5 calls per second and a maximum of 2 instant messages per second should be allowed. The substream classifier (e.g., substream classifier 104) implements a SIP pattern matching algorithm over the SIP data contents 102b. The pattern matching algorithm recognizes the SIP request types “INVITE” and “MESSAGE.” Packets matching these patterns are classified into substreams SSᵢₙᵥᵢₜₑ and SS_{message} respectively. All other request types and responses are classified into SSₒₜₕₑᵣ. The substream classifier 104 directs traffic based on the substream to one of three substream policers (e.g., 106a-c) named Pᵢₙᵥᵢₜₑ, P_{message}, and Pₒₜₕₑᵣ respectively.

The three substream policers are single-floor token bucket policers (e.g., substream policer 106a of FIG. 4). Pᵢₙᵥᵢₜₑ is sized with a bucket size 406b of five tokens and a token fill rate 406a of five tokens per second. One token is required to be available to pass an INVITE request. P_{message} is sized with a bucket size 406b of two tokens and a token fill rate 406a of two tokens per second. One token is required to be available to pass a MESSAGE request. Pₒₜₕₑᵣ is sized with a bucket size 406b of three tokens and a token fill rate 406a of three tokens per second. One token is required to be available to pass an “other” packet.

The priority classifier 108 determines the appropriate priority to be applied in the aggregate policer 110. To ensure INVITEs which pass the substream policer (e.g., substream policer 106a) have priority over MESSAGEs which pass the substream policer (e.g., substream policer 106b), the priority classifier 108 must map the respective packets to floor values Fᵢₙᵥᵢₜₑ and F_{message} such that Fᵢₙᵥᵢₜₑ<F_{message}. Similarly, to ensure MESSAGEs which pass the substream policer 106b have priority over OTHER packets which pass the substream policer (e.g., substream policer 106c), the priority classifier 108 must map the respective packets to priority values F_{message} and Fₒₜₕₑᵣ such that F_{message}<Fₒₜₕₑᵣ. The priority classifier 108 implements a mapping which produces the described ordering of priority values (e.g., priority value 109) and passes the packet (e.g., prioritized packets 508 of FIG. 6) and priority values (e.g. priority value 109 of FIG. 6) to the aggregate policer 110.

The aggregate policer 110 includes a multi-floor token bucket 604. The aggregate policer 110 is sized with a bucket size 606d of ten tokens and a token fill rate 606a of ten tokens per second. One token at the respective floor level (e.g., floor level (Fᵢ) 606b) is required to pass a packet. The floor level Fᵢ 606b to use for a particular packet is provided by the priority classifier 108. When presented with a packet (e.g., prioritized packets 508 of FIG. 6) and a priority value (e.g., priority value 109 of FIG. 6), the aggregate policer 110 determines whether there is at least one token above the specified floor level Fᵢ 606b for the priority class 109. If a corresponding token is available, then the token is deducted from the multi-floor token bucket 604 and the packet is allowed (e.g., allowed packets 608). Otherwise, the packet (e.g., dropped packets 610) is dropped and no token is removed from the multi-floor token bucket 604.

If a packet is dropped 610, a drop indicator 612 is directed to the logical gate 112 along with the assigned substream indicator 702 for the dropped packet (e.g., Pᵢₙᵥᵢₜₑ, P_{message}, and Pₒₜₕₑᵣ). The logical gate 112 directs a charge command 412 to the respective substream policer (e.g., substream policer 106a) that had previously allowed the request. For example, if the aggregate policer 110 drops a request from the substream Pᵢₙᵥᵢₜₑ, the logical gate 112 directs the charge command 412 to the Pᵢₙᵥᵢₜₑ substream policer (e.g., substream policer 106a). The substream policer (e.g., substream policer 106a) undoes a charge that it had previously applied when it allowed the packet by increasing the token count 406c of the single-floor token bucket 404 in the substream policer 106a by one.

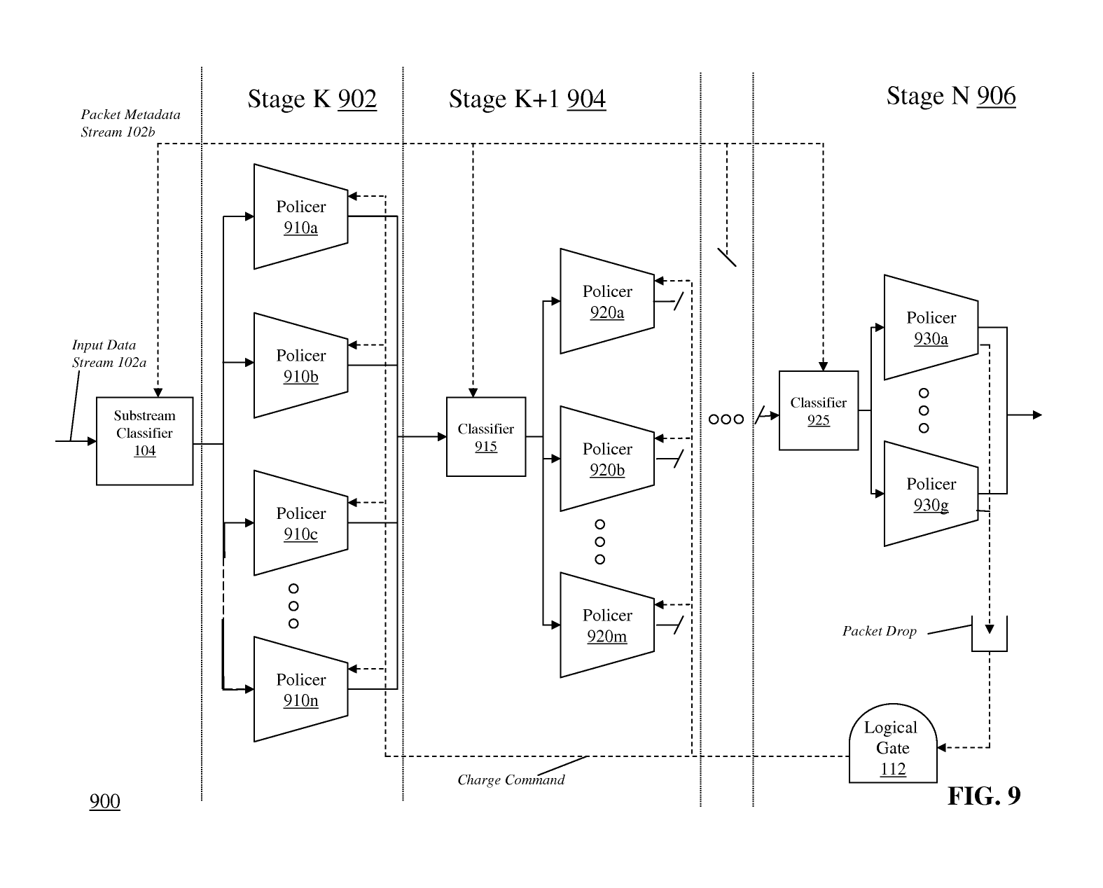

The above techniques and embodiments are described using a two-stage policing structure (e.g., a set of substream policers (e.g., substream policers 106a-n) and an aggregate policer (e.g., aggregate policer 110)). In some embodiments, however, the invention is implemented using any number of policing stages. In some embodiments, each subsequent policing stage includes fewer policers than the previous policing stage. For example, the invention can be implemented using an N-stage policing structure, where N is greater than or equal to 2. FIG. 9 is a block diagram of an exemplary system 900 for policing and prioritizing data services with N policing stages. The system 900 includes a plurality of policers 910a-n (where ‘n’ denotes the number of substream policers) in a policing stage K 902, a plurality of policers 920a-m (where ‘m’ is less than ‘n’) in a policing stage K+1 904, and a plurality of policers 930a-1 (where ‘1’ is less than ‘m’) in a policing stage N 906. The system 900 also includes a packet data stream 102a, a packet metadata stream 102b, a substream classifier 104, and a logical gate 112. In some embodiments, the system 900 includes a substream classifier (e.g., substream classifier 104) preceding the policers (e.g., policers 910a-n) in the policing stage K 902 and a classifier (e.g., classifiers 915 and 925) preceding the policers in each of the subsequent policing stages. For example, the classifier 915 precedes the policers 920a-m in the policing stage K+1 904 and the classifier 925 precedes the policers 930a-g in the policing stage N 906. In addition, in some embodiments, the system 900 includes a priority classifier (e.g., priority classifier 108 of FIG. 1) for each policing stage. In some embodiments, the classifiers 915 and 925 act as priority classifiers. In some embodiments, the policers (e.g., policers 920a-m, policers 930a-g) are priority policers which prioritize packets as the packets are processed.

In one embodiment, the substream classifier 104 receives an input data stream 102a and a packet metadata stream 102b associated with the input data stream 102a, and classifies each packet in the input data stream 102a based on one or more attributes of the packet. The substream classifier 104 directs each packet to one of the policers 910a-n in the policing stage K 902 based on the classification. The policer (e.g., policer 910a) in the policing stage K 902 determines whether to allow the packet through the policer 910a based on rate parameters associated with the policer 910a (e.g., a maximum rate and burst size for the specific stream). The policer 910a in the policing stage K 902 drops unallowed packets. The policer 910a in the policing stage K 902 directs allowed packets to a classifier (e.g., classifier 915) in the policing stage K+1 904. The classifier 915 determines which policer (e.g., policer 920a) in the policing stage K+1 904 receives each allowed packet based on one or more attributes associated with each packet. The policer 920a in the policing stage K+1 904 determines whether to allow the packets allowed by the policer 910a in the policing stage K 902 through the policer 920a in the policing stage K+1 904 based on rate parameters associated with the policer 920a in the policing stage K+1 904. The policer 920a in the policing stage K+1 904 directs allowed packets to a classifier in a subsequent policing stage (not shown). A classifier (e.g., classifier 925) in the policing stage N 906 receives packets allowed by all of the previous policing stages (including the policing stage K 902 and the policing stage K+1 904). The classifier 925 determines which policer (e.g., policer 930a) in the policing stage N 906 receives the packets allowed by all of the previous policing stages based on one or more attributes associated with each packet. The policer 930a receiving the packets from the classifier 915 in the policing stage N 906 determines whether to allow the packets allowed by all of the previous policing stages through the policer 930a in the policing stage N 906 based on rate parameters associated with the policer 930a in the policing stage N 906.

The policer (e.g., policer 930a) in the policing stage N 906 drops unallowed packets and transmits a drop indicator to a logical gate 112. The logical gate 112 directs a charge command to the policer (e.g., policer 910a and policer 920a) of each policing stage (e.g., policing stage K 902 and policing stage K+1 904) that allowed a packet if the packet was dropped by a policer (e.g., policer 930a) in the policing stage N 906. The policer (e.g., policer 910a and policer 920a) undoes a previously-applied charge based on the charge command received from the logical gate 112.

In another embodiment, the policer (e.g., policer 930a) in the policing stage N 906 transmits an allow indicator to a logical gate 112 if the policer (e.g., policer 930a) allows a packet. The logical gate 112 directs a charge command to the policer (e.g., policer 910a and policer 920a) of each policing stage (e.g., policing stage K 902 and policing stage K+1 904) that allowed a packet if the packet was allowed by a policer (e.g., policer 930a) in the policing stage N 906. The policer (e.g., policer 910a and policer 920a) applies a previously-deferred charge based on receiving the charge command from the logical gate 112.

For example, the substream policer (e.g. substream classifier 104) receives packets in a data stream (e.g., input data stream 102a) and direct the packets to a policer (e.g., policer 910a) of a plurality of policers in a first policing stage (e.g., policing stage K 902). The policer (e.g., policer 910a) determines whether to allow the packet through the policer (e.g., policer 910a) in the first policing stage (e.g., policing stage K 902) based on rate parameters associated with the policer in the first policing stage. The policer (e.g., policer 910a) directs the packet allowed by the policer (e.g., policer 910a) in the first policing stage (e.g., policing stage K 902) to a classifier (e.g., classifier 915) in a second policing stage K+1 904, wherein the second policing stage K+1 904 comprises fewer policers than the first policing stage K 902. The classifier 915 determines which policer (e.g., policer 920a) in the policing stage K+1 904 receives the allowed packets. In some embodiments, the classifier 915 directs a packet allowed by the policer (e.g., policer 910a) in the first policing stage (e.g., policing stage K 902) to the policer (e.g., policer 920a) in the second policing stage (e.g., policing stage K+1 904) based on a predetermined relationship between the policer in the first policing stage and the policer in the second policing stage. In other embodiments, the classifier 915 directs a packet allowed by the policer (e.g., policer 910a) in the first policing stage (e.g., policing stage K 902) to the policer (e.g., policer 920a) in the second policing stage (e.g., policing stage K+1 904) based on one or more attributes of the packet.

The policer (e.g., policer 920a) in the second policing stage (e.g., policing stage K+1 904) determines whether to allow the packet allowed by the first policing stage (e.g., policing stage K 902) through the second policing stage (e.g., policing stage K+1 904) based on rate parameters associated with the policer (e.g., policer 920a) in the second policing stage (e.g., policing stage K+1 904). If the packet is allowed by a policer in every policing stage (e.g., policing stages K 902 and policing stage K+1 904), the policers (e.g., policer 910a and policer 920a) are charged for the packet. If the packet has not been allowed by a policer in every policing stage, the policers are not charged.

In some embodiments, the policer (e.g., policer 920a) in the second policing stage (e.g., policing stage K+1 904) directs allowed packets to a classifier (e.g., classifier 925) in a third policing stage (e.g., policing stage N 906), wherein the third policing stage comprises fewer policers than the second policing stage. The classifier 925 determines which policer (e.g., policer 920a) in the third policing stage N 906 receives the allowed packets. In some embodiments, the classifier 925 directs a packet allowed by the policer (e.g., policer 920a) in the second policing stage (e.g., policing stage K+1 904) to the policer (e.g., policer 930a) in the third policing stage (e.g., policing stage N 906) based on a predetermined relationship between the policer in the second policing stage and the policer in the third policing stage. The two policers 920a and 930a can have a predetermined relationship in that the policer 920a in the second policing stage directs its traffic to the policer 930a in the third policing stage.

In some embodiments, the classifier 915 directs a packet allowed by the policer (e.g., policer 920a) in the second policing stage (e.g., policing stage K+1 904) to the policer (e.g., policer 930a) in the third policing stage (e.g., policing stage N 906) based on one or more attributes of the packet.

The policer (e.g., policer 930a) in the third policing stage (e.g., policing stage N 906) determines whether to allow the packet allowed by the second policing stage through the third policing stage based on rate parameters associated with the policer in the third policing stage. In still other embodiments, there are one or more additional policing stages (e.g., a fourth policing stage, a fifth policing stage), where each subsequent policing stage comprises fewer policers than the immediately previous policing stage. For example, the fourth policing stage comprises fewer policers than the third policing stage.

The above-described techniques can be implemented in digital and/or analog electronic circuitry, or in computer hardware, firmware, software, or in combinations of them. The implementation can be as a computer program product, i.e., a computer program tangibly embodied in a machine-readable storage device, for execution by, or to control the operation of, a data processing apparatus, e.g., a programmable processor, a computer, and/or multiple computers. A computer program can be written in any form of computer or programming language, including source code, compiled code, interpreted code and/or machine code, and the computer program can be deployed in any form, including as a stand-alone program or as a subroutine, element, or other unit suitable for use in a computing environment. A computer program can be deployed to be executed on one computer or on multiple computers at one or more sites.

Method steps can be performed by one or more processors executing a computer program to perform functions of the invention by operating on input data and/or generating output data. Method steps can also be performed by, and an apparatus can be implemented as, special purpose logic circuitry, e.g., a FPGA (field programmable gate array), a FPAA (field-programmable analog array), a CPLD (complex programmable logic device), a PSoC (Programmable System-on-Chip), ASIP (application-specific instruction-set processor), or an ASIC (application-specific integrated circuit), or the like. Subroutines can refer to portions of the stored computer program and/or the processor, and/or the special circuitry that implement one or more functions.

Processors suitable for the execution of a computer program include, by way of example, both general and special purpose microprocessors, and any one or more processors of any kind of digital or analog computer. Generally, a processor receives instructions and data from a read-only memory or a random access memory or both. The essential elements of a computer are a processor for executing instructions and one or more memory devices for storing instructions and/or data. Memory devices, such as a cache, can be used to temporarily store data. Memory devices can also be used for long-term data storage. Generally, a computer also includes, or is operatively coupled to receive data from or transfer data to, or both, one or more mass storage devices for storing data, e.g., magnetic, magneto-optical disks, or optical disks. A computer can also be operatively coupled to a communications network in order to receive instructions and/or data from the network and/or to transfer instructions and/or data to the network. Computer-readable storage mediums suitable for embodying computer program instructions and data include all forms of volatile and non-volatile memory, including by way of example semiconductor memory devices, e.g., DRAM, SRAM, EPROM, EEPROM, and flash memory devices; magnetic disks, e.g., internal hard disks or removable disks; magneto-optical disks; and optical disks, e.g., CD, DVD, HD-DVD, and Blu-ray disks. The processor and the memory can be supplemented by and/or incorporated in special purpose logic circuitry.

To provide for interaction with a user, the above described techniques can be implemented on a computer in communication with a display device, e.g., a CRT (cathode ray tube), plasma, or LCD (liquid crystal display) monitor, for displaying information to the user and a keyboard and a pointing device, e.g., a mouse, a trackball, a touchpad, or a motion sensor, by which the user can provide input to the computer (e.g., interact with a user interface element). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, and/or tactile input.

The above described techniques can be implemented in a distributed computing system that includes a back-end component. The back-end component can, for example, be a data server, a middleware component, and/or an application server. The above described techniques can be implemented in a distributed computing system that includes a front-end component. The front-end component can, for example, be a client computer having a graphical user interface, a Web browser through which a user can interact with an example implementation, and/or other graphical user interfaces for a transmitting device. The above described techniques can be implemented in a distributed computing system that includes any combination of such back-end, middleware, or front-end components.

The components of the computing system can be interconnected by transmission medium, which can include any form or medium of digital or analog data communication (e.g., a communication network). Transmission medium can include one or more packet-based networks and/or one or more circuit-based networks in any configuration. Packet-based networks can include, for example, the Internet, a carrier internet protocol (IP) network (e.g., local area network (LAN), wide area network (WAN), campus area network (CAN), metropolitan area network (MAN), home area network (HAN)), a private IP network, an IP private branch exchange (IPBX), a wireless network (e.g., radio access network (RAN), Bluetooth, Wi-Fi, WiMAX, general packet radio service (GPRS) network, HiperLAN), and/or other packet-based networks. Circuit-based networks can include, for example, the public switched telephone network (PSTN), a legacy private branch exchange (PBX), a wireless network (e.g., RAN, code-division multiple access (CDMA) network, time division multiple access (TDMA) network, global system for mobile communications (GSM) network), and/or other circuit-based networks.

Information transfer over transmission medium can be based on one or more communication protocols. Communication protocols can include, for example, Ethernet protocol, Internet Protocol (IP), Voice over IP (VOIP), a Peer-to-Peer (P2P) protocol, Hypertext Transfer Protocol (HTTP), Session Initiation Protocol (SIP), H.323, Media Gateway Control Protocol (MGCP), Signaling System #7 (SS7), a Global System for Mobile Communications (GSM) protocol, a Push-to-Talk (PTT) protocol, a PTT over Cellular (POC) protocol, and/or other communication protocols.

Devices of the computing system can include, for example, a computer, a computer with a browser device, a telephone, an IP phone, a mobile device (e.g., cellular phone, personal digital assistant (PDA) device, laptop computer, electronic mail device), and/or other communication devices. The browser device includes, for example, a computer (e.g., desktop computer, laptop computer) with a world wide web browser (e.g., Microsoft® Internet Explorer® available from Microsoft Corporation, Mozilla® Firefox available from Mozilla Corporation). Mobile computing device include, for example, a Blackberry®. IP phones include, for example, a Cisco® Unified IP Phone 7985G available from Cisco Systems, Inc, and/or a Cisco® Unified Wireless Phone 7920 available from Cisco Systems, Inc.

Comprise, include, and/or plural forms of each are open ended and include the listed parts and can include additional parts that are not listed. And/or is open ended and includes one or more of the listed parts and combinations of the listed parts.

One skilled in the art will realize the invention may be embodied in other specific forms without departing from the spirit or essential characteristics thereof. The foregoing embodiments are therefore to be considered in all respects illustrative rather than limiting of the invention described herein.

What is claimed is:

1. A method for policing and prioritizing of data services, the method comprising:
directing each packet in a data stream to a substream policer of a plurality of substream policers;
determining whether to allow each packet through the substream policer based on rate parameters associated with the substream policer;
directing the packets allowed by the substream policer to an aggregate policer;
determining whether to allow each packet allowed by the substream policer through the aggregate policer based on rate parameters associated with the aggregate policer;
charging the substream policer and the aggregate policer for each packet allowed by both the substream policer and the aggregate policer; and
not charging the substream policer and the aggregate policer for each packet not allowed by either the substream policer or the aggregate policer.

2. The method of claim 1, wherein directing each packet in a data stream to a substream policer of a plurality of substream policers further comprises selecting the substream policer based on one or more attributes of the packet.

3. The method of claim 2, wherein the one or more attributes of the packet comprise at least one of content data associated with the packet or metadata associated with the packet.

4. The method of claim 3, wherein the content data associated with the packet comprises at least one of data associated with one or more network protocol headers of the packet, data associated with one or more application headers of the packet or data associated with the packet payload.

5. The method of claim 3, wherein the metadata associated with the packet comprises at least one of a packet arrival interface, upstream router identification, VLAN identification or access medium identification.

6. The method of claim 2, wherein selecting the substream policer based on one or more attributes of the packet further comprises assigning a substream identifier to the packet based on the selected substream policer.

7. The method of claim 1, wherein not charging the substream policer and the aggregate policer for each packet not allowed by either the substream policer or the aggregate policer comprises charging the substream policer for each packet allowed at the time the packet is allowed by the substream policer, not charging the aggregate policer for each packet not allowed by the aggregate policer, and undoing the charge of the substream policer for each packet not allowed by the aggregate policer.

8. The method of claim 1, wherein charging the substream policer and the aggregate policer for each packet allowed by both the substream policer and the aggregate policer comprises deferring a charge of the substream policer for each packet allowed by the substream policer until the packet is allowed by the aggregate policer.

9. The method of claim 1, wherein charging the substream policer and the aggregate policer for each packet allowed by both the substream policer and the aggregate policer comprises charging the substream policer for each packet allowed at the time the packet is allowed by the substream policer, and charging the aggregate policer for each packet allowed at the time the packet is allowed by the aggregate policer.

10. The method of claim 1, wherein determining whether to allow each packet, allowed by the substream policer, through the aggregate policer further comprises not allowing a packet, dropping the packet, and directing a drop indicator to a logical gate.

11. The method of claim 10, wherein the logical gate directs a command to the substream policer to update a state associated with the substream policer based on the drop indicator.

12. The method of claim 11, comprising identifying the substream policer based on a substream identifier assigned to the dropped packet.

13. The method of claim 11, comprising identifying the substream policer based on a substream identifier assigned to the drop indicator.

14. The method of claim 1, wherein the aggregate policer is a priority policer and the packets are prioritized by the priority policer after being allowed by the substream policer.

15. The method of claim 14, wherein prioritizing the packets allowed by the substream policer further comprises:
classifying each of the allowed packets based on one or more attributes of the allowed packet; and
assigning a priority to the allowed packet based on the classification.

16. The method of claim 15, wherein classifying each of the allowed packets is not based on the determination by the substream policer to allow the packet.

17. The method of claim 15, wherein the one or more attributes of the packet comprise at least one of content data associated with the packet or metadata associated with the packet.

18. The method of claim 17, wherein the content data associated with the packet comprises at least one of data associated with one or more network protocol headers of the packet, data associated with one or more application headers of the packet or data associated with the packet payload.

19. The method of claim 17, wherein the metadata associated with the packet comprises at least one of a packet arrival interface, upstream router identification, VLAN identification or access medium identification.

20. The method of claim 2, wherein the aggregate policer is a priority policer and the packets are prioritized by the priority policer after being allowed by the substream policer.

21. The method of claim 20, wherein prioritizing the packets allowed by the substream policer further comprises:
classifying each of the allowed packets based on one or more attributes of the allowed packet; and
assigning a priority to the allowed packet based on the classification.

22. The method of claim 21, wherein classifying each of the allowed packets is not based on the determination by the substream policer to allow the packet.

23. The method of claim 21, wherein the one or more attributes of the packet used to select the substream policer are different than the one or more attributes of the packet used to classify the allowed packet.

24. The method of claim 1, wherein each substream policer operates independently of any other substream policers.

25. The method of claim 24, wherein the determination made by a substream policer of whether to allow a packet does not affect the determination made by any other substream policers of whether to allow any other packets.

26. The method of claim 1, wherein the plurality of substream policers comprise token bucket policers, leaky bucket policers, or any combination thereof.

27. The method of claim 1, wherein the aggregate policer comprises a token bucket policer or a leaky bucket policer.

28. The method of claim 1, wherein the rate parameters associated with the substream policer comprise at least one of the traffic rate or the burst size.

29. The method of claim 1, wherein the rate parameters associated with the aggregate policer comprise at least one of the traffic rate or the burst size.

30. A method for policing and prioritizing of data services with N policing stages, wherein N is greater than 2, the method comprising:
a) directing a packet in a data stream to a policer in a policing stage K, wherein the policing stage K comprises a plurality of policers;
b) determining whether to allow the packet through the policer in the policing stage K based on rate parameters associated with the policer in the policing stage K;
c) directing the packet allowed by a policer in the policing stage K to a policer in a subsequent policing stage K+1, wherein the policing stage K+1 comprises fewer policers than the policing stage K;
d) determining whether to allow the packet allowed by the policing stage K through the policing stage K+1 based on rate parameters associated with the policer in the policing stage K+1;
e) charging a policer for the packet if the packet has been allowed by a policer in each of the N policing stages; and
f) not charging a policer for the packet if the packet has not been allowed by a policer in any one of the N policing stages.

31. A system for policing and prioritizing of data services, the system comprising:
a substream classification module configured to direct a packet in a data stream to a substream policer of a plurality of substream policers based on one or more attributes of the packet, wherein the substream policer is configured to determine whether to allow the packet through the substream policer based on rate parameters associated with the substream policer;
an aggregate policer configured to receive the packet allowed by the substream policer and determine whether to allow it through the aggregate policer based on rate parameters associated with the aggregate policer; and
a logical gate configured to send a command to the substream policer to either (i) charge the substream policer if the packet has been allowed by the aggregate policer or (ii) undo a charge of the substream policer if the packet has not been allowed by the aggregate policer.

32. The system of claim 31, further comprising a priority classification module configured to prioritize the packet allowed by the substream policer based on one or more attributes of the packet allowed by the substream policer.

33. A system for policing and prioritizing of data services, the system comprising:
means for directing each packet in a data stream to a substream policer;
means for determining whether to allow each packet through the substream policer based on rate parameters associated with the substream policer;
means for directing the packets allowed by the substream policer to an aggregate policer;
means for determining whether to allow each packet allowed by the substream policer through the aggregate policer based on rate parameters associated with the aggregate policer; and
means for charging the substream policer and the aggregate policer for each packet allowed by both the substream policer and the aggregate policer; and
means for not charging the substream policer and the aggregate policer for each packet not allowed by either the substream policer or the aggregate policer.

34. A computer program product, tangibly embodied in a computer readable storage medium, for policing and prioritizing of data services, the computer program product including instructions operable to cause a data processing apparatus to:
direct each packet in a data stream to a substream policer;
determine whether to allow each packet through the substream policer based on rate parameters associated with the substream policer;
direct the packets allowed by the substream policer to an aggregate policer;
determine whether to allow each packet allowed by the substream policer through the aggregate policer based on rate parameters associated with the aggregate policer; and
charge the substream policer and the aggregate policer for each packet allowed by both the substream policer and the aggregate policer; and
not charge the substream policer and the aggregate policer for each packet not allowed by either the substream policer or the aggregate policer.
